(19) United States
(12) Patent Application Publication
(10) Pub. No.: US 2004/0141319 A1
(43) Pub. Date: Jul. 22, 2004

(54) Ornamental garland with light string

(76) Inventor: Kuo-Hao Huang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/653,554

(22) Filed: Sep. 2, 2003

(30) Foreign Application Priority Data
Jan. 21, 2003 (DE) 20300947.9

(51) Int. Cl. F21S 2/00

(52) U.S. Cl. 362/227

(57) ABSTRACT

An ornamental garland has a translucent tube inside which multiple light strings and two wires are retained, where a garland is wrapped around the translucent tube. Each light string is composed of multiple light emitting diodes (LEDs) or tungsten filaments. The two wires are respectively connected to two ends of each light string whereby all lights strings are connected in parallel. Further, since the two wires are made from metal material having a proper strength and is bendable, the ornament garland is easily deformed to form any particular shape as required and maintained at such an expected configuration.

### BACKGROUND OF THE INVENTION

1. Field of the Invention

The present invention relates to an ornamental garland, and more particularly to an ornamental garland wrapped with a light string to increase the decorative effect.

2. Description of Related Art

A conventional ornamental light string is normally formed by wires along which multiple light emitting elements such as the light bulbs are electrically connected. A normally used means to connect the light bulbs and the wires comprises light sockets that are disposed on the wires, whereby the light bulbs are retained inside those light sockets.

Moreover, since the light string's visual effect is only made up by light bulbs without any further decorations, the entire appearance is impaired due to the directly exposed wires. Thus, garlands are often applied and together with the light string to decorate any articles.

With reference to FIG. 6, however, people must firstly construct a desired pattern by means of garlands and frames, and secondly to wrap the light string on the garland. Sometimes those light bulbs on the light string are assembled to the light sockets one by one by in a manual operation which is particularly inefficient.

Obviously, such an assembling process to construct a complete decoration at least includes two steps which greatly increase the complexity of assembling.

To overcome the shortcomings, the present invention tends to provide an improved ornamental garland with a light string to mitigate and obviate the aforementioned problems.

### SUMMARY OF THE INVENTION

The primary objective of the present invention is to provide an ornamental garland twisting with a light string to enhance the decorative effect.

In order to accomplish the foregoing objective, the ornamental garland of the present invention is composed of:

a light string made up by light emitting elements and wire segments, wherein each wire segment has two ends respectively and electrically connected to two adjacent light emitting elements thereby making the light emitting elements to be connected in series;

a translucent tube, wherein two power wires together with the light string are enclosed inside the translucent tube, where the two power wires are electrically connected to the light string to provide operating voltage; and

a garland twisted around the translucent tube.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a portion of an ornamental garland in accordance with the present invention;

FIG. 2 shows one embodiment of a light string in accordance with the present invention;

FIG. 3 is a cross-sectional view of a part of the light string and a translucent tube in accordance with the present invention;

FIG. 4 shows multiple light strings are connected in parallel;

FIG. 5 is a schematic view showing a garland is twisted around the light string of FIG. 3; and

FIG. 6 shows a conventional ornamental garland decorated with a light string.

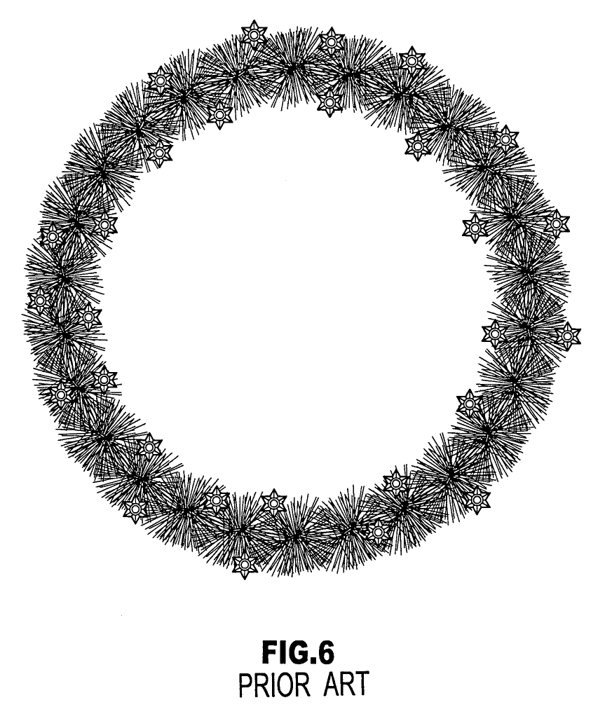

### DETAILED DESCRIPTION OF THE PREFERRED EMBODIMENT

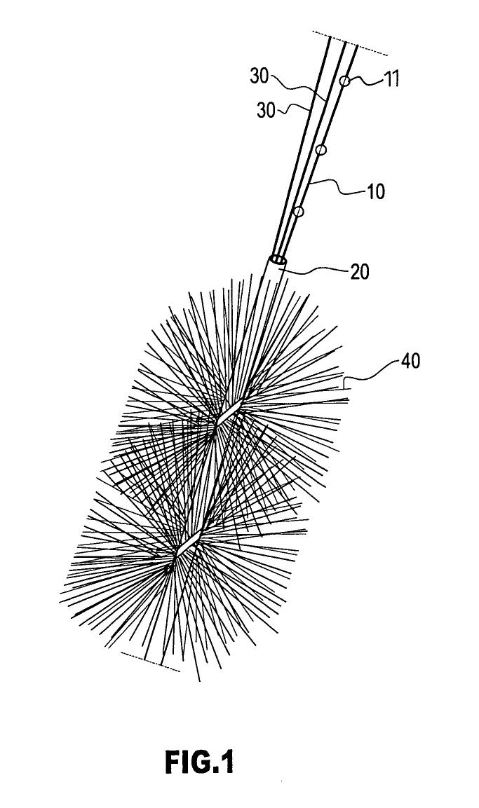

With reference to FIG. 1, a part of an ornamental garland in accordance with the present invention is shown, which is composed of at least one light string (10), a translucent tube (20), two wires (30) and a garland (40) winded around the translucent tube (20).

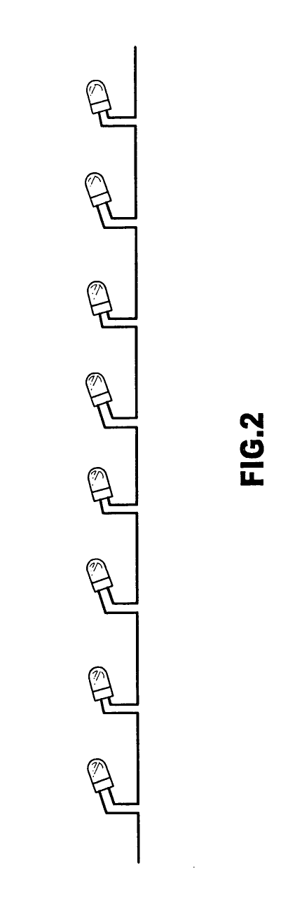

In the present invention, the light string (10) is formed by multiple light emitting elements, such as light emitting diodes (LEDs) (11), connected in series. As an example, for two adjacent LEDs (11), the cathode of the first LED (11) is connected to the anode of the second LED (11), where the cathode of the second LED (11) is for connection to the next following LED. By repeating the foregoing connecting process, a complete LED light string is formed. Moreover, each LED (11) is coated with a light pervious glue casing made of insulating material and having a substantially ball-shaped configuration. The glue casing is applied to protect the LED (11) chip to prevent the chip from being polluted by any contaminants such as dust and moisture. However, it is noted that the general lamps (as shown in FIG. 2) formed by the tungsten filaments are also feasible.

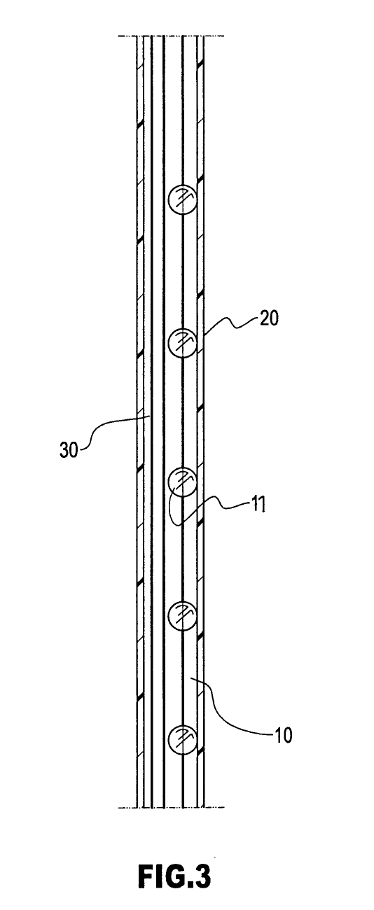

With reference to FIGS. 1 and 3, the light string (10) accompanied with the two wires (30) is enclosed by the translucent tube (20). The two wires (30) are not only connected to the light string (10) to provide operating voltage, but are also adopted as the strengtheners. Since the wires (30) are made from metal material having a proper strength, the two wires (30) are able to increase the strength of the entire ornamental light string and allow the light string to be deformed into any shape as required. The translucent tube (20) is made of heat-shrinking material, i.e. the thermolplastic, to tightly retain the light string (10) and the strengthener (30) therein.

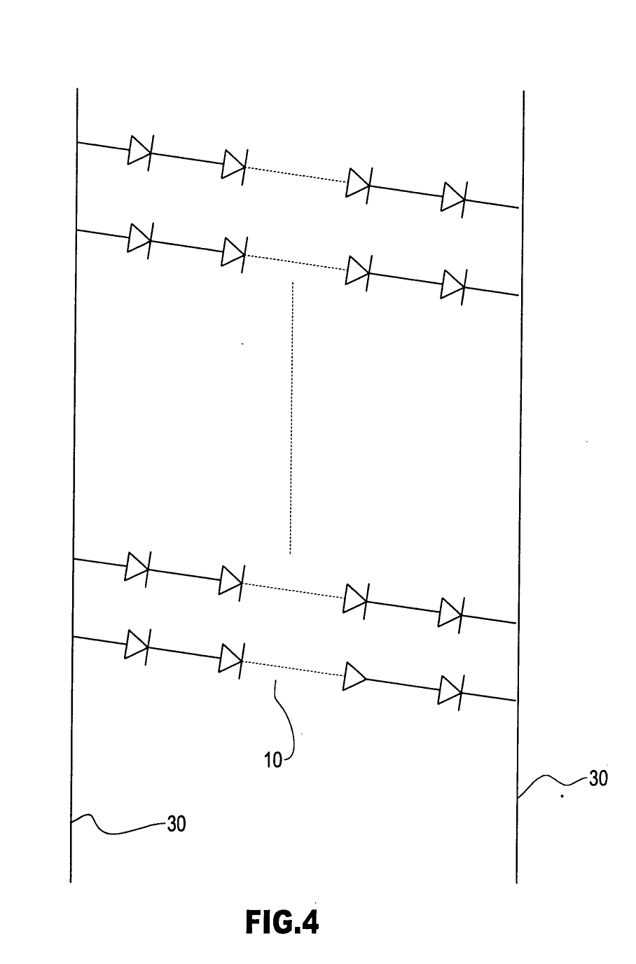

With reference to FIG. 4, plural light strings (10) connected in parallel are able to be assembled inside the translucent tube (30), wherein the two wires (30) are respectively connected to two ends of each light string (10). With such a connection topology, even when one light string (10) has any failure, the remaining light strings (10) are still able to be activated normally.

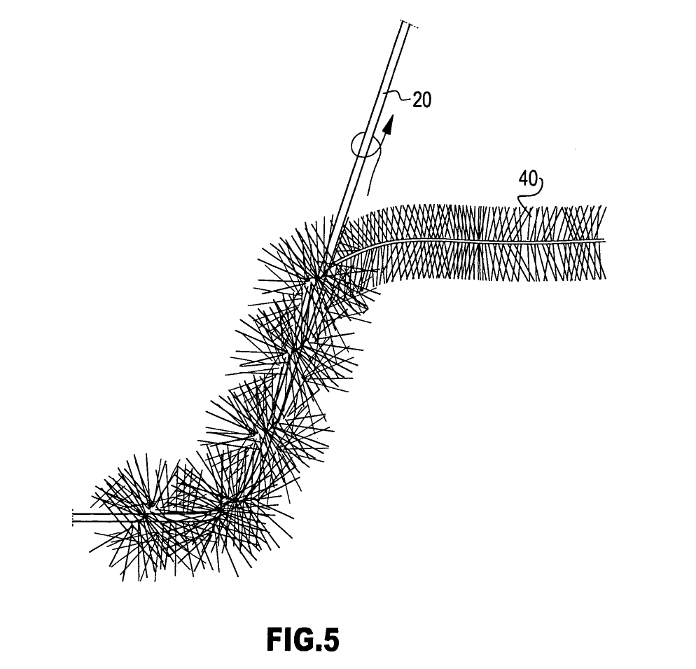

With reference to FIG. 5, after the light string (10) and the wires (30) are assembled inside the translucent tube (20), the garland (40) is wrapped around and secured to the outer surface of the translucent tube (20) as indicating by the twisted arrow symbol. After that process, the assembled ornamental light string of the present invention is able to be bent to any particular configuration as required. Further, when the light string is lit, the garland (40) is able to reflect a part of light to provide a fascinating effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ornamental garland comprising:
a light string made up by multiple light emitting elements that are connected in series;
a translucent tube, wherein two wires together with the light string are enclosed inside the translucent tube, where the two wires are electrically connected to the light string to provide an operating voltage; and
a garland wrapped around the translucent tube.

2. The ornamental garland as claimed in claim 1, wherein each light emitting element is a light emitting diode (LED).

3. The ornamental garland as claimed in claim 1, wherein each light emitting element is a lamp with tungsten filament.

4. The ornamental garland as claimed in claim 2, wherein each LED is provided with a light pervious glue casing so as to protect the LED.

5. The ornamental garland as claimed in claim 1, wherein the translucent tube is made of heat-shrinking material.

6. The ornamental garland as claimed in claim 2, wherein the translucent tube is made of heat-shrinking material.

7. The ornamental garland as claimed in claim 3, wherein the translucent tube is made of heat-shrinking material.

8. The ornamental garland as claimed in claim 4, wherein the translucent tube is made of heat-shrinking material.

9. An ornamental garland comprising:
a plurality of light strings, wherein each light string is made up by multiple light emitting elements that are connected in series;
a translucent tube, wherein two wires together with the plurality of light strings are enclosed inside the translucent tube, where the two wires are respectively and electrically connected to two ends of each light string whereby all light strings are connected in parallel; and
a garland wrapped around the translucent tube.

10. The ornamental garland as claimed in claim 9, wherein each light emitting element is a light emitting diode (LED).

11. The ornamental garland as claimed in claim 9, wherein each light emitting element is a lamp with tungsten filament.

12. The ornamental garland as claimed in claim 10, wherein each LED is provided with a light pervious glue casing so as to protect the LED.

13. The ornamental garland as claimed in claim 9, wherein the translucent tube is made of heat-shrinking material.

14. The ornamental garland as claimed in claim 10, wherein the translucent tube is made of heat-shrinking material.

15. The ornamental garland as claimed in claim 11, wherein the translucent tube is made of heat-shrinking material.

16. The ornamental garland as claimed in claim 12, wherein the translucent tube is made of heat-shrinking material.
